(19) United States
(12) Patent Application Publication
(10) Pub. No.: US 2005/0264209 A1
(43) Pub. Date: Dec. 1, 2005

(54) Plasma display panel and method of manufacturing the same

(76) Inventors: Yon-Goo Park, Suwon-si (KR); Hyea-Weon Shin, Suwon-si (KR); Tae-Ho Lee, Suwon-si (KR)

Correspondence Address: MCGUIREWOODS, LLP, 1750 TYSONS BLVD, SUITE 1800, MCLEAN, VA, 22102, US

(21) Appl. No.: 11/138,398

(22) Filed: May 27, 2005

(30) Foreign Application Priority Data
May 28, 2004 (KR) 10-2004-0038164

(51) Int. Cl. H01J 17/49

(52) U.S. Cl. 313/586; 313/582; 313/584

(57) ABSTRACT

A plasma display panel including a first substrate, a second substrate, barrier ribs formed between the first substrate and the second substrate to partition discharge cells, address electrodes formed to correspond to the discharge cells, respectively, display electrodes formed on the first substrate in a direction substantially perpendicular to the address electrodes, a dielectric layer that substantially covers the display electrodes, and a carbon nanotube layer formed in the dielectric layer.

### CROSS REFERENCE TO RELATED APPLICATION

This application claims priority to and the benefit of Korean Patent Application No. 10-2004-0038164, filed on May 28, 2004, which is hereby incorporated by reference for all purposes as if fully set forth herein.

### BACKGROUND OF THE INVENTION

1. Field of the Invention

The present invention relates to a plasma display panel (PDP) that displays images.

2. Discussion of the Background

Generally, a PDP displays images by gas discharge. More specifically, the gas discharge creates plasma, which emits vacuum ultraviolet (VUV) rays that excite phosphors, and the phosphors emit red (R), green (G), and blue (B) visible rays to form an image. The PDP's screen may be larger than 60 inches, and it may be formed 10 cm or less thick. Additionally, since the PDP is a self-emissive display device, it may have high color reproducibility and no distortion caused by viewing angle. Further, since the PDP may be manufactured easier than a liquid crystal display (LCD) panel, it may have higher productivity and lower manufacturing costs. Thus, the PDP has drawn attention as a next-generation flat panel display.

Generally, in an alternating current (AC) PDP, address electrodes are formed on a rear substrate in one direction, and a dielectric layer is formed covering the address electrodes. Then, strip-shaped barrier ribs are formed on the dielectric layer in parallel with, and between, the address electrodes, and red (R), green (G), and blue (B) phosphor layers are formed between the barrier ribs, respectively.

Further, display electrode pairs, such as a sustain electrode and a scan electrode, are formed on a surface of the front substrate facing the rear substrate and in a direction substantially perpendicular to the address electrodes. Each display electrode may include a transparent electrode for generating a surface discharge and a bus electrode for applying a discharge voltage. A dielectric layer covers the display electrodes and a protective layer, which may be made of magnesium oxide (MgO), covers the dielectric layer.

A discharge cell is formed at each intersection of an address electrode and a display electrode pair.

In this way, millions of discharge cells may be arranged in a matrix in the PDP, and a memory characteristic may be used to simultaneously drive the discharge cells in the AC PDP.

More specifically, a potential difference, which is referred to as a firing voltage V_{f}, higher than a predetermined voltage is needed to generate a discharge between the sustain electrode and the scan electrode of a display electrode pair. In this case, when an address voltage is applied between the scan electrode and the address electrode, an address discharge starts, thereby generating plasma in the discharge cells. Then, electrons and ions in the plasma move to electrodes having different polarities, respectively, which causes the flow of current.

As noted above, since dielectric layers are formed on the AC PDP's electrodes, most of the space charges accumulate on the dielectric layers having different polarities. Therefore, a net space potential between the scan electrode and the address electrode may become lower than an address voltage Va that is first applied, which causes a low discharge voltage. As a result, the address discharge stops. At that time, a relatively small number of electrons may be accumulated on the sustain electrode, and a relatively large number of ions may be accumulated on the scan electrode. The charges accumulated on the dielectric layer that covers the scan electrode and the sustain electrode are referred to as wall charges (Qw), and a space voltage formed between the scan electrode and the sustain electrode by these wall charges is referred to as a wall voltage (Vw).

When applying a predetermined voltage Vs (discharge sustain voltage) between the sustain electrode and the scan electrode, if a voltage obtained by adding the discharge sustain voltage Vs and the wall voltage Vw (Vs+Vw) is higher than the firing voltage Vf, a discharge occurs in the corresponding discharge cell. Then, the generated VUV rays excite the phosphor layers, and visible rays are emitted from the transparent front substrate to display images.

However, in such a PDP, in order to improve brightness, the amount of emitted secondary electrons may be increased when ions collide with each other in the discharge cells. Accordingly, various techniques using carbon nanotubes have been developed for this purpose.

### SUMMARY OF THE INVENTION

The present invention provides a PDP and a method of manufacturing the same that may have improved brightness, low-voltage driving, and high efficiency by increasing the amount of emitted secondary electrons in discharge cells using a carbon nanotube.

Additional features of the invention will be set forth in the description which follows, and in part will be apparent from the description, or may be learned by practice of the invention.

The present invention discloses a PDP including a first substrate, a second substrate, barrier ribs formed between the first substrate and the second substrate to partition discharge cells, address electrodes formed corresponding to the discharge cells, respectively, display electrodes formed on the first substrate in a direction substantially perpendicular to the address electrodes, a dielectric layer that substantially covers the display electrodes, and a carbon nanotube layer formed in the dielectric layer.

The present invention also discloses a method of manufacturing a PDP including forming display electrodes on a first substrate, forming a first dielectric layer to cover the display electrodes, forming a carbon nanotube layer on the first dielectric layer, and forming a second dielectric layer to substantially cover the carbon nanotube layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded perspective view showing a PDP according to an exemplary embodiment of the invention.

FIG. 2 is a cross-sectional view taken along line II-II of FIG. 1.

FIG. 3A, FIG. 3B, FIG. 3C and FIG. 3D are cross-sectional views showing a first substrate manufacturing process of a method for manufacturing a PDP according to an exemplary embodiment of the invention.

### DETAILED DESCRIPTION OF THE ILLUSTRATED EMBODIMENTS

Hereinafter, exemplary embodiments of the invention will be described with reference to the accompanying drawings.

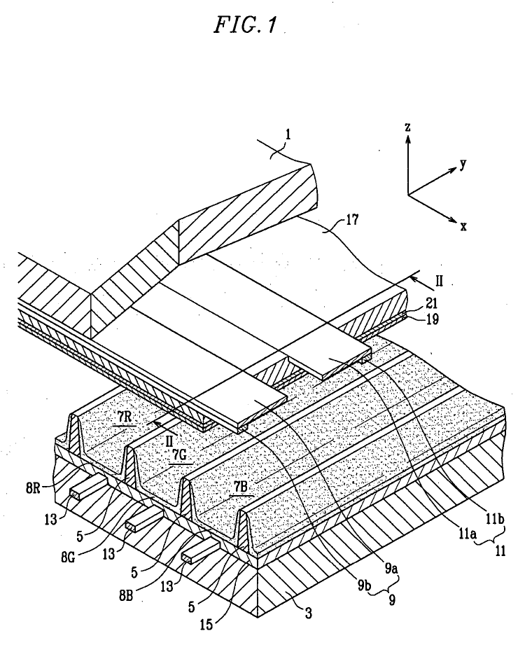

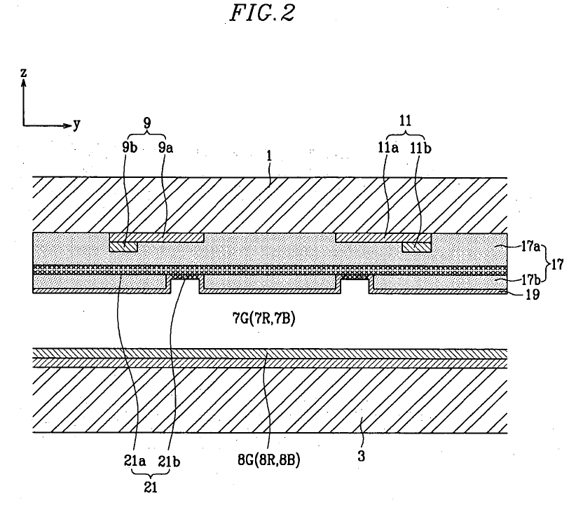

FIG. 1 is an exploded perspective view showing a plasma display panel (PDP) according to an exemplary embodiment of the invention.

Referring to FIG. 1, the PDP may include a first substrate 1 (front substrate) and a second substrate 3 (rear substrate) joined together, and an inert gas may be injected between the front substrate 1 and the rear substrate 3. A plurality of barrier ribs 5 may be provided in a space between the front substrate 1 and the rear substrate 3 to define a plurality of discharge cells 7R, 7G, and 7B. Additionally, red (R), green (G), and blue (B) phosphors 8R, 8G, and 8B are formed in these discharge cells 7R, 7G, and 7B, respectively.

Display electrodes 9 and 11 may be formed on the front substrate 1 and extending in the x-axis direction of FIG. 1, and they may be arranged at intervals corresponding to the respective discharge cells 7R, 7G, and 7B in the y-axis direction. Additionally, address electrodes 13 may be formed on the rear substrate 3 and extending in a direction (the y-axis direction of FIG. 1) substantially perpendicular to the display electrodes 9 and 11. The address electrodes 13 may be arranged at intervals corresponding to the respective discharge cells 7R, 7G, and 7B in the x-axis direction of FIG. 1. In other words, the display electrodes 9 and 11 and the address electrodes 13 are arranged perpendicular and parallel to the discharge cells 7R, 7G, and 7B, respectively.

The barrier ribs 5 may be arranged parallel to each other at predetermined intervals between the front substrate 1 and the rear substrate 3, thereby partitioning the discharge cells 7R, 7G, and 7B required for plasma discharge. While FIG. 1 shows a strip-type partition structure in which the barrier ribs 5 are formed along a direction (the y-axis direction of FIG. 1) parallel to the address electrodes 13, the present invention is not limited thereto.

Accordingly, a closed partition structure may be utilized in which the discharge cells 7R, 7G, and 7B are independently partitioned by the barrier ribs 5 formed parallel to the address electrodes 13 and barrier ribs (not shown) formed in a direction (the x-axis direction of FIG. 1) perpendicular to the barrier ribs 5. For example, the partition structure of the invention includes a closed partition structure in which each of the discharge cells 7R, 7G, and 7B is formed in a rectangular shape, a hexagonal shape, or an octagonal shape.

The address electrodes 13 may be formed on the rear substrate 3, as shown in FIG. 1. However, the invention is not limited thereto. For example, the address electrodes 13 may be formed on the front substrate 1 or on the barrier ribs. A dielectric layer 15 covers the address electrodes 13 and generates wall charges for address discharge in the respective discharge cells 7R, 7G, and 7B. The barrier ribs 5 may be formed on the dielectric layer 15.

The display electrodes 9 and 11 may be formed of a sustain electrode and a scan electrode 9 and 11 corresponding to both sides of each discharge cell 7R, 7G, and 7B. Additionally, as FIG. 1 shows, the sustain electrode and the scan electrode 9 and 11 may be formed on the front substrate 1. However, the invention is not limited thereto. For example, an intermediate electrode (not shown) for scanning and addressing may be formed between the sustain electrode and the scan electrode 9 and 11 on the front substrate 1.

Further, as FIG. 1 shows, the sustain electrode and the scan electrode 9 and 11 may include transparent electrodes 9a and 11a and bus electrodes 9b and 11b, respectively. Alternatively, the sustain and scan electrodes may include either the transparent electrodes 9a and 11a or the bus electrodes 9b and 11b. When the intermediate electrode (not shown) is included, it may be made of the same material as the sustain electrode and the scan electrode 9 and 11, and it may be formed in the same structure as the sustain electrode and the scan electrode 9 and 11, which simplifies the manufacturing process.

The transparent electrodes 9a and 11a may be formed in a strip type extending in a direction (the x-axis direction of FIG. 1) substantially perpendicular to the address electrodes 13. Alternatively, for example, the transparent electrodes may be formed in a plurality of protruded pieces in which the transparent electrode protrusions project toward the center of each discharge cell 7R, 7G, and 7B. The transparent electrodes 9a and 11a generate a surface discharge in the respective discharge cells 7R, 7G and 7B, and they may cover large areas of the discharge cells 7R, 7G, and 7B. Consequently, the transparent electrodes 9a and 11a may be made of a transparent material, such as, for example, indium tin oxide (ITO) in order to minimally shield visible rays and ensure brightness of the PDP.

The bus electrodes 9b and 11b may compensate for the transparent electrodes' high resistance to enhance the electrical conductivity of the transparent electrodes 9a and 11a. Thus, the bus electrodes 9b and 11b may be made of a metallic material having high electrical conductivity, such as, for example, aluminum. The bus electrodes 9b and 11b may be respectively laminated on the transparent electrodes 9a and 11a to extend in the direction (the x-axis direction of FIG. 1) substantially perpendicular to the address electrodes 13.

Further, the bus electrodes 9b and 11b may be made of an opaque material, and when the barrier ribs are formed in a closed structure, the bus electrodes may be arranged to correspond to the barrier ribs. Additionally, the bus electrodes 9b and 11b may be formed narrower than the barrier rib 5 so as to minimally shield visible rays emitted from the discharge cells 7R, 7G, and 7B.

A dielectric layer 17 may cover the display electrodes 9 and 11, and a protective layer 19, which may be an MgO layer, covers the dielectric layer 17, thereby forming a laminated structure that stores wall charges. The dielectric layer 17 may be made of a transparent dielectric material to improve the transmittance of visible rays. The protective layer 19 prevents the dielectric layer 17 from damage due to collision with ions, and it facilitates emission of secondary electrons during gas discharge.

FIG. 2 is a cross-sectional view taken along line II-II of FIG. 1.

The dielectric layer 17 will now be described with reference to FIG. 2. The dielectric layer 17 has a carbon nanotube layer 21 therein. The carbon nanotube layer 21 may be formed in a predetermined pattern in the dielectric layer 17. The carbon nanotube layer 21 may increase the amount of emitted secondary electrons without interrupting the emission of visible rays or the addressing operation between the address electrodes 13 and the sustain electrode or the scan electrode 9 or 11 (generally, the scan electrode). Thus, the carbon nanotube layer 21 may improve the ratio of power consumption to brightness, (i.e. emission efficiency), thereby improving brightness.

The pattern of the carbon nanotube layer 21 may be obtained by patterning the dielectric layer 17.

In this case, the dielectric layer 17 may include a first dielectric layer 17a and a second dielectric layer 17b, and the carbon nanotube layer 21 may be interposed therebetween. Hence, the first dielectric layer 17a may be formed on the display electrodes 9 and 11, and the carbon nanotube layer 21 may be formed on the first dielectric layer 17a. The second dielectric layer 17b may then be formed on the carbon nanotube layer 21 and patterned such that a portion of the carbon nanotube layer 21 is exposed. Accordingly, the carbon nanotube layer 21 may be formed covering the first dielectric layer 17a, and the second dielectric layer 17b having an opening pattern may be formed on the carbon nanotube layer 21.

Consequently, according to the pattern of the second dielectric layer 17b, the carbon nanotube layer 21 includes portions 21a that are covered with the second dielectric layer 17b and portions 21b that are exposed by the opening pattern of the second dielectric layer 17b. The exposed portions 21b may be formed so as to correspond to edge portions of the display electrodes 9 and 11 that are located closer to the center of the discharge cell 7G in order to increase the amount of emitted secondary electrons and to perform low-voltage driving. More specifically, the exposed portions 21b of the carbon nanotube layer 21 may correspond to edges of the transparent electrodes 9a and 11a.

Further, the first dielectric layer 17a may be formed about 10 to 20 μm thick. Then, the carbon nanotube layer 21 may be formed thereon, and the second dielectric layer 17b may be formed on the carbon nanotube layer 21. The second dielectric layer 17b may then be patterned. Here, the thickness of the dielectric layer 17 differs in the patterned portions and non-patterned portions, which may have the same effect as that obtained when the carbon nanotube layer 21 is patterned.

Since the portions 21b of the carbon nanotube layer 21 exposed by the opening pattern of the second dielectric layer 17b are not covered by the second dielectric layer 17b, the portions 21b may have carbon nanotubes that are more upright than that of the portions 21a that are covered with the second dielectric layer 17b. However, since the protective layer 19 may cover the exposed portions 21b, the uprightness of the carbon nanotube may not cause a problem. That is, the protective layer 19 covers the second dielectric layer 17b and the portions 21b of the carbon nanotube layer 21 exposed by the second dielectric layer 17b opening pattern.

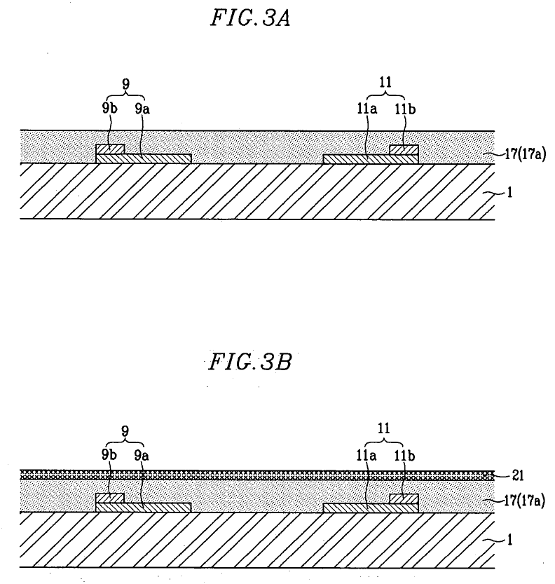

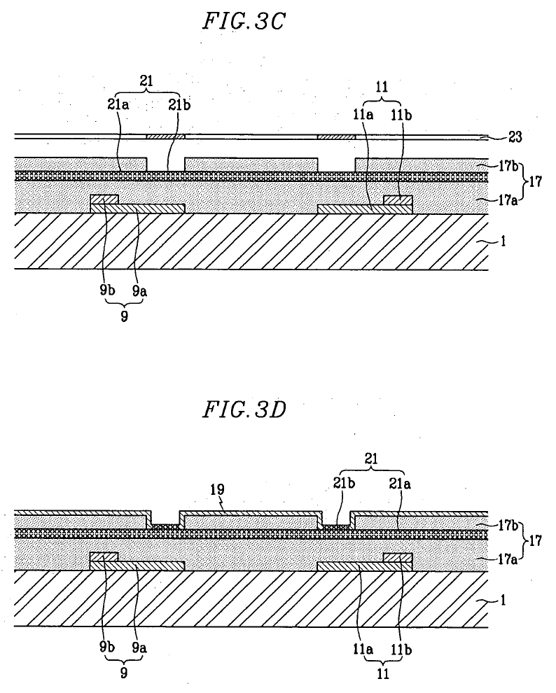

FIG. 3A, FIG. 3B, FIG. 3C and FIG. 3D are cross-sectional views showing a first substrate manufacturing process of a method of manufacturing the PDP according to an exemplary embodiment of the invention.

Referring again to FIG. 1, manufacturing a PDP may include a process of forming the display electrodes 9 and 11 on the first substrate 1, of forming the address electrodes 13 on the second substrate 3, of forming the barrier ribs 5 for partitioning the discharge cells 7R, 7G; and 7B, of forming phosphor layers 8R, 8G; and 8B, of bonding the first and second substrates 1 and 3 together, and of creating a vacuum in the space between the first and second substrates 1 and 3, injecting an inert gas thereinto, and sealing it.

Since the processes described above may be performed by a well-known method, a detailed description thereof will be omitted.

Further, since the transparent electrodes 9a and 11a and the bus electrodes 9b and 11b may be formed using a well-known method, a detailed description thereof will be omitted.

Hence, a process of patterning the carbon nanotube layer 21 on the dielectric layer 17 will be described herein.

Referring to FIG. 3A, FIG. 3B, FIG. 3C and FIG. 3D, the display electrodes 9 and 11 including the transparent electrodes 9a and 11a and the bus electrodes 9b and 11b may be formed on the first substrate 1, and then the first dielectric layer 17a may be formed on the display electrodes 9 and 11 (see FIG. 3A). Here, the first dielectric layer 17a may be formed about 10 to 20 μm thick.

Then, the carbon nanotube layer 21 may be formed on the first dielectric layer 17a (see FIG. 3B). Here, the carbon nanotube layer 21 may be formed substantially covering the first dielectric layer 17a.

The second dielectric layer 17b may then be formed on the carbon nanotube layer 21 (see FIG. 3C). In this case, the dielectric layer formed on the carbon nanotube layer 21 may be patterned to expose portions of the carbon nanotube layer 21.

For example, the second dielectric layer 17b may be patterned by a printing method using a screen mask 23 or by an exposure/development method. When using the exposure/development method, the second dielectric layer 17b or the dielectric layer 17 may be made of a photosensitive dielectric material.

After patterning the second dielectric layer 17b, a protective layer 19, which may be made of MgO, for example, may be formed thereon (see FIG. 3D). The protective layer 19 substantially covers the second dielectric layer 17b and the exposed portions 21b of the carbon nanotube layer 21, thereby protecting the dielectric layer 17 and the carbon nanotube layer 21.

As described above, according to a PDP of exemplary embodiments of the invention, a first dielectric layer and a carbon nanotube layer may be formed on display electrodes on a first substrate, and a second dielectric layer may be formed on the carbon nanotube layer with an opening pattern corresponding to the display electrodes. The carbon nanotube layer may increase the amount of emitted secondary electrons in the discharge cells, resulting in improved discharge efficiency (the ratio of power consumption to brightness). Consequently, it may be possible to improve brightness and achieve low-voltage driving.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel (PDP), comprising:
a first substrate;
a second substrate;
barrier ribs formed between the first substrate and the second substrate to partition discharge cells;
address electrodes formed corresponding to the discharge cells, respectively;
display electrodes formed on the first substrate in a direction substantially perpendicular to the address electrodes;
a dielectric layer that substantially covers the display electrodes; and
a carbon nanotube layer formed in the dielectric layer.

2. The PDP of claim 1, wherein the dielectric layer includes a first dielectric layer and a second dielectric layer, the carbon nanotube layer being interposed between the first dielectric layer and the second dielectric layer.

3. The PDP of claim 2, wherein the second dielectric layer is formed in a pattern on the carbon nanotube layer.

4. The PDP of claim 2, wherein the carbon nanotube layer substantially covers the first dielectric layer.

5. The PDP of claim 2, wherein the carbon nanotube layer includes first portions that are covered by the second dielectric layer and second portions that are exposed by an opening pattern of the second dielectric layer.

6. The PDP of claim 5, wherein a second portion of the carbon nanotube layer corresponds to an edge portion of a display electrode, the edge portion of the display electrode being near a center of a discharge cell.

7. The PDP of claim 5, further comprising a protective layer substantially covering the second portions of the carbon nanotube layer and the second dielectric layer.

8. The PDP of claim 2, wherein the first dielectric layer is about 10 to 20 μm thick.

9. The PDP of claim 1, further comprising a phosphor layer in each discharge cell.

10. A method of manufacturing a plasma display panel, comprising:
forming display electrodes on a first substrate;
forming a first dielectric layer to substantially cover the display electrodes;
forming a carbon nanotube layer on the first dielectric layer; and
forming a second dielectric layer to substantially cover the carbon nanotube layer.

11. The method of claim 10, further comprising patterning the second dielectric layer to expose portions of the carbon nanotube layer.

12. The method claim 11, further comprising forming a protective film substantially covering the patterned second dielectric layer and the exposed portions of the carbon nanotube layer.

13. The method of claim 11, wherein patterning the second dielectric layer comprises using a printing method with a screen mask.

14. The method of claim 11, wherein patterning the second dielectric layer comprises using an exposure/development method, the second dielectric layer being made of a photosensitive dielectric material.

15. The method of claim 11, wherein patterning the second dielectric layer includes exposing a portion of the carbon nanotube layer that corresponds to an edge of a display electrode, the edge of the display electrode being disposed near a center of a discharge cell.
